(19) United States
(12) Patent Application Publication
(10) Pub. No.: US 2008/0289566 A1
(43) Pub. Date: Nov. 27, 2008

(54) Bookmark and method of employment for product advertising, reading encouragement, and contests

(76) Inventor: Jeffrey Allen Hallman, Ramona, CA (US)

Correspondence Address: DONN K. HARMS;PATENT & TRADEMARK LAW CENTER, SUITE 100, 12702 VIA CORTINA, DEL MAR, CA, 92014, US

(21) Appl. No.: 12/154,077

(22) Filed: May 19, 2008

Related U.S. Application Data
(60) Provisional application No. 60/930,603, filed on May 17, 2007.

(51) Int. Cl. B42D 9/00

(52) U.S. Cl. 116/234

(57) ABSTRACT

A device and method for encouraging reading employing a bookmark for engagement to the spine, covers, or pages of a book. Coupons tradeable for rewards or sequentially removable portions from the bookmark to reveal indicia indicating increased reading achievement are provided as inducement to readers for reading.

### FIELD OF THE INVENTION

This application is a Continuation-in-Part of and claims the benefit of U.S. Provisional Application No. 60/930,603, filed on May 17, 2007, and incorporated herein in its entirety by reference. The disclosed system and method relates generally to bookmarks. More particularly, it relates to a bookmark which has a base portion which is user-engageable to the spine, covers, or pages of a book, and is equipped with a tail portion extending from the base portion and adapted for insertion between pages to mark a point in the book for return. The base portion is employable in an especially preferred mode of the device and method herein for advertising products or vendors of books or other services and products to the user, for reading and literacy encouragement, or for contests, lotteries and raffles and to provide subsequent advertising of the same.

### BACKGROUND OF THE INVENTION

A bookmark is a thin marker, commonly made from paper or leather or plastic in a thin planar component and employed to mark the user's place in a printed work to enable the user to close the book and upon return, find the marked position in the book at a later time with ease.

In the early days of printing, books were quite rare and valuable and readers ascertained early on that some manner was needed to mark their place in a book without causing the pages or components of the book any harm. Modern books, while not especially valuable, are manufactured of paper which is easily damaged or bent. Consequently, a prerequisite for a good bookmark is that it will do no harm to the pages or other parts of the book on which it is employed.

Modern bookmarks are available in a huge variety of materials with a multitude of designs and styles from which to choose. Conventional materials for such bookmarks are cardboard or heavy paper, but other modern bookmarks are known to be manufactured of leather, ribbon, fabric, felt, wire, plastic, vinyl, or other materials which are flexible, thin, and planar and therefore employable between the closed pages of a book.

With the advent of high speed color printing, most modern hard cover books also employ a jacket or cover which is engaged over the spine and two hard covers of the book. These jackets usually have color indicia and graphics printed on a thin sheet of paper and both decorate and protect the covers and spine of the book when engaged thereto.

A vexing problem with most such bookmarks such as thin paper sheets or ribbons is maintaining the bookmark with the book during reading sessions and while transporting the book. Permanent attachment can cause damage to the book itself, and simple insertion can be easily dislodged when the book is carried or pages loosened.

Additionally, in modern American with the advent of television, video games, and the internet, there has been a great decline in reading by young readers in the United States. Books have trouble competing with modern electronic games and online and electronic media for the attention and interest of new young readers and especially those in their teens. This has caused a decline in reading, vocabulary, and reading comprehension ability in such readers and follows them into adulthood.

With reading and literacy in the United States is in decline, there is a need for some type of method for encouraging young and older readers alike to increase their reading time and thereby improve their knowledge, comprehension, and other reading skills.

Many people, especially the young, respond to simple awards such as a badge that proclaims the amount of reading they have accomplished to third parties. The device and method herein can be employed for this purpose by using sequential numbers which can be placed on sequential bookmarks that the reader would be allowed to attach to each book to show others the amount they have read. At a certain point, a bookmark that is special, for instance, with a gold star or some other symbol of record accomplishment, would be obtained by the readers to place on their books to show their accomplishment to others and increase self-esteem. Other readers, such as those in their teens, may respond to awards of food, product discounts, and the like, in addition to bookmarks with indicia proclaiming their reading prowess. Either way, reading and literacy is increased.

However, because many books may be loaned from school or city libraries, may be borrowed, or may just be part of a private collection, it is important that the book itself not be damaged in any such reward or self-esteem type method and device. It is also important that the device and method be adaptable to suite the goals or response of the individual readers using it. That being said, it is important that the device be maintained proximate to the book by default, to encourage use and provide a constant reminder to the reader of the goal in mind while they read, and thus the device will facilitate constant reading sessions rather than hinder them.

As such, there exists an unmet need for a bookmark that is engageable to the cover, spine, book jacket of a book, or to the interior pages that will maintain the bookmark in the proximity of the book to which it is to be employed for marking. Such a device should not cause damage to the book parts or jacket cover at the site of the engagement thereto. Such a device ideally should also be employable for an advertisement of the vendor of the book to encourage the large scale deployment of the devices to users at minimal or no cost.

Further, such a device should be distributable to potential users to be later engaged to books in programs to encourage reading and literacy such as with children. Employed as a system for reading encouragement, the bookmarks can be used as badges or signs showing other parties the reader's current reading accomplishments to continue to encourage them to read more. Or, they can be employed in combination with discounts on products, coupons, and the like as awards for reading.

Such pre-distributed bookmarks should be easily user-engageable, and by including indicia for advertising will encourage wide and inexpensive employment thereof and encourage purchase and reading of books by readers young and old.

Additionally, because the device consists of a base engaged to a tail section, it can be constructed with frangible portions that may be employed as discount coupons for books, or related or unrelated products such as pizza. Or, using scrapable portions on the base, lottery or contest numbers might be imparted to the base portion so that users can engage in a contest or lottery using the bookmarks as the vehicle of transport for the winning numbers which can provide inducement for readers to read more through contests distributing the bookmarks.

In all modes of the device, whether carrying indicia, frangible coupons or portions to the base, or layered base portions that are removable from underlying portions, the attachment to the book should be easy and cause no harm to the book itself. Ideally the means of attachment should render the base portion and hence the device, removably engageable in the event the user wishes to detach it without harming the book, or to relocate the device to an attachment to another book.

It is thus an object of this invention to provide a bookmark that is easily attached to any book, and which has a means of attachment that will not harm the book itself, to provide a proximate reminder of the goal or program.

It is a further object of this invention to provide such a device which employs a means of attachment that is removable with no harm to the book, and/or relocatable to another book for use therewith.

It is a further object of this invention to provide such a book mark which may be employed as in a method of advertising of related and unrelated items to the book being marked to thereby encourage sponsors and thus inexpensive distribution to readers.

It is an additional object of this invention to provide such a bookmark advertising method and apparatus that employs one or a plurality of removable portions from the engageable base portion of the device to provide a means of fund-raising for organizations or revenue to aid in distribution.

It is yet an additional object of this invention to provide such a bookmark advertising method and apparatus that employs one or a plurality of removable portions from the engageable tail or ribbon portion of the device to allow for ongoing sequential rewards or encouragement by providing sequentially displayed indicia which depicts increasing achievement by the holder.

It is another object of this invention to provide a method for encouraging reading through the provision of such bookmarks having advertising upon them thereby rendering them inexpensive or free to users.

A still further object of this invention is to provide a method for encouraging reading through the provision of bookmarks with indicia such as sequential numbers or colored stars which are awarded to readers as a badge of accomplishment for others to observe.

Yet another object of this invention is to provide a method for encouraging reading through the provision of such bookmarks having advertising upon them giving the bearer of the bookmark discounts on products as a reward for accomplishment.

With respect to the above description and background, before explaining at least one preferred embodiment of the invention in detail, it is to be understood that the invention is not limited in its application to the details of construction and to the arrangement of the components and/or steps set forth in the following description or illustrated in the drawings. The various apparatus and methods of the invention herein described and disclosed are capable of other embodiments and of being practiced and carried out in various ways which will be obvious to those skilled in the art once they review this disclosure. Also, it is to be understood that the phraseology and terminology employed herein are for the purpose of description and should not be regarded as limiting.

As such, those skilled in the art will appreciate that the conception upon which this disclosure is based may readily be utilized as a basis for designing of other devices, methods and systems for carrying out the several purposes of the present disclosed device for marking books and providing reading inducement through advertising on the bookmarks to users. It is important, therefore, that the objects and claims be regarded as including such equivalent construction and methodology, insofar as they do not depart from the spirit and scope of the present invention.

### SUMMARY OF THE INVENTION

The embodiments of the device disclosed herein are directed at bookmarks that are engageable to books for marking positions in the book for return visits. All embodiments employ a base portion that is engageable to a book and a tail portion that extends from an attachment to the base portion to a distal end. The tail portion is thin and elongated so that placement between book pages for prolonged periods will not cause damage to the book. Thread, planar strips of paper or plastic or foil, or other materials thin and elongated in nature would be employed for this tail portion.

The base is engageable to the book itself and it is important to employ a means of engagement which will not harm the book to which it engages. A particularly preferred means of such engagement would be adhesive adapted to hold the base portion to the book or cover, yet also be removable if desired. This will allow engagement during reading of the book and subsequent removal so that the book need not have the device engaged for long durations and will allow the device to be redeployed to subsequent books. Also, using this type of attachment will allow the base portion to be attached to the exterior of the book where indicia and advertising thereon can be read by the user and any third parties within viewing distance of the base portion so engaged.

To the base portion is engaged a tail portion which extends to a distal end. It is important that the tail portion be sufficiently thin so as not to harm the book or pages between which it is lodged. Threads, ribbons, plastic or foil strips, or paper work particularly well for this purpose with some types of material being more adapted to use as a carrier for indicia or detachable coupons for user use and advertiser distribution.

It is particularly preferred to employ the devices in a method of advertising. In such a method, the bookmarks would be given to users and would carry indicia thereon identifying the advertiser to both the user and third parties viewing the engaged base or extending ribbon portion with advertisers' indicia thereon. Using such advertising allows for inexpensive distribution to users by the advertisers, and benefits to the advertisers when read or viewed by the users and other third parties who will view the book when transported.

Also, in a particularly preferred mode of the device and method, a detachable portion would be provided with the bookmark. The detachable portion could be a frangible portion of the base, or if paper or planar material is employed for the ribbon, a separable portion thereof can form the detachable portion. These detachable portions would be employed as coupons for related or unrelated products to the books on which the bookmarks will be engaged. Thus, the bookmark can serve as a vehicle for coupon distribution for many types of products or services, and generally the advertisers or bookmark publishers would provide the bookmarks free or at significant discounts to users who will profit from both the bookmark use and product and service discounts imparted to the coupons.

One such detachable portion would be one or a plurality of perforated portions of the base or the ribbon on which coupons would be imparted through indicia situated thereon. The user can thus separate the coupons from the bookmark and employ them for the product and service discounts and engage the rest of the bookmark to the book.

Another preferred mode of the device employing a detachable portion would have a multilayer base portion where a top surface would be separable from underlying layers. In this mode the coupon or advertising would be imparted to this top surface layer and easily removed for use by the user either before or after engagement of the bookmark to the book.

In yet another preferred mode of the device, it would be employed as an inducement to increase reading of literature to young readers. In one mode of this method, bookmarks bearing indicia as to the number of pages or books read would be awarded to readers, teachers or the like. As the reader increases their accomplishment, sequentially higher award indicia would be depicted on the awarded bookmarks which would be attached to the next book of the reader as a badge of accomplishment. Or, sequential indicia may be displayed when overlain indicia is removed on removable portions of the bookmark with the sequential indicia indicating a higher achievement level. Once a certain predetermined level of accomplishment is reached, the reader would be awarded a bookmark with a gold star or other easy recognizable achievement indicia.

The bookmarks may be distributed by book vendors in classrooms as badges of accomplishment or rewards or as material inducements for readers by placing discount or coupon indicia on the base portion, the tail portion, or a detachable portion. The bearer of the bookmark would be able to take it to a book vendor designated by the indicia on the bookmark and receive a discount or other inducement for brining in the bookmark. In cases of young readers, the device could be given away in classrooms and allow the young readers to visit a bookstore and receive a prize or a discount on a purchased book.

If used as a reward for accomplishing a reading milestone such as a number of pages or books read, the indicia on the base or tail may also be for some type of non-book product such as ice cream or pizza. In the reward mode of the device and method, the bookmarks would be awarded to users reaching certain milestones for reading and could be later tendered to retailers or other parties who would give the bearer the indicated reward such a candy or pizza, a discount on a book or video game, or some other material inducement adapted to encourage the intended user to read.

Consequently, while the structure itself using a removably engageable base portion adapted for engagement without harming the book is an advancement over detached bookmarks, the combination with advertising or inducements using indicia to provide the bearer with discounts or rewards is an especially novel and useful advancement for both advertisers, product vendors, and the user who will benefit from free or discounted devices and discounts of related and unrelated products and services.

The foregoing summary and following detailed description are considered as illustrative only of the principles of the invention. Further, since numerous modifications and changes will readily occur to those skilled in the art, it is not desired to limit the invention to the exact construction and methods and steps shown and described, and accordingly, all suitable modifications and equivalents which may be resorted to, are considered to be fall within the scope of the invention.

### BRIEF DESCRIPTION OF DRAWINGS

FIG. 1 depicts the device engaged to the preferred position on the exterior of a book with indicia thereon for advertising and a tail extending to a distal end therefrom engaged between book pages as a marker.

FIG. 2 is a view of the device showing the base portion and a ribbon style tail extending to a distal end.

FIG. 3 is a slice through FIGS. 1 and 2 showing the top layer and an adhesive layer for attachment to one or a sequential plurality of books without damaging it.

FIG. 4 depicts another preferred mode of the device where the separable portion is a layer which may be peeled from the top surface of the base portion and a thread-like tail portion.

FIG. 4a is a slice through FIG. 4 showing the layers, the separable component and the adhesive.

FIG. 5 shows a tear-off or frangible portion of the base yielding the separable portion on a side edge which can be employed as a coupon or discount card.

FIG. 5a is a slice through FIG. 5 showing the separable portion and adhesive only on the non separable portion.

FIG. 6 shows the device as a lottery ticket with a scratch off portion.

FIG. 7 depicts multiple separable portions as part of a second planar tail along with a tail for employment in the book.

FIG. 8 depicts the device employed as a raffle ticket with a separable portion as a ticket stub and the remainder of the base used to advertise the event, vendor, or location and raffle time.

FIG. 9 depicts a mode of the device used in a method to encourage readers by making the bookmark into a badge or plaque to announce achievement with sequential numbers or indicia on underlying indicia showing increased achievement, such as colored stars.

### DETAILED DESCRIPTION OF PREFERRED EMBODIMENTS

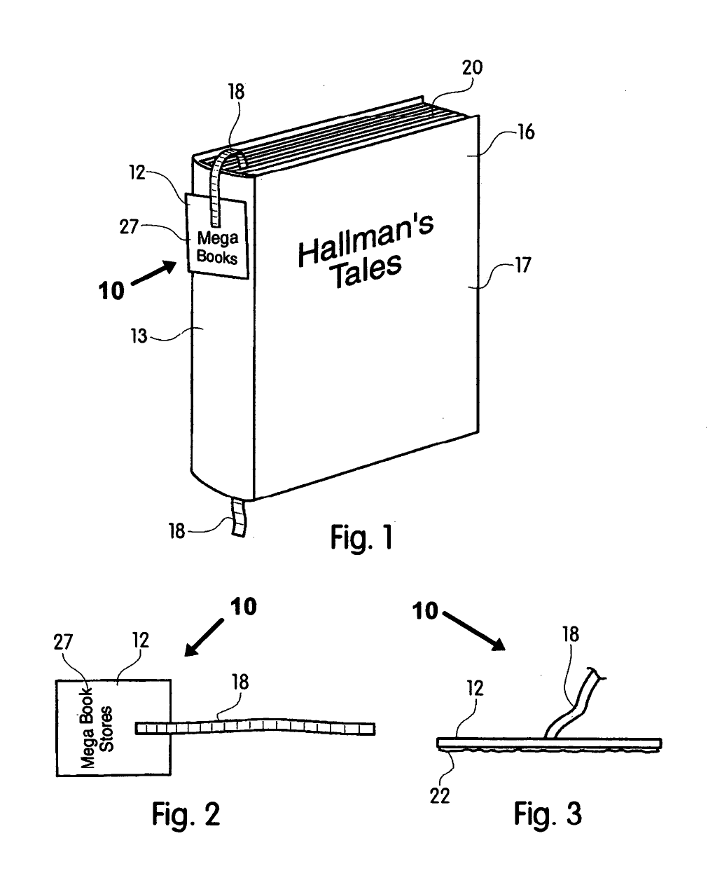

Referring now to the drawings in FIGS. 1-9, the device 10 and method is described and disclosed in some preferred modes and similar parts are identified by like reference numerals which may be found in one or more of the drawings. The disclosed device 10 is depicted in the drawings for employment with the method of encouragement herein, and may be employed as an improved bookmark, or in combination with the system or method, may be employed to encourage reading, to advertise, or used as a raffle or lottery ticket distribution.

As shown in FIG. 1, in the mounted position, the device 10 in all modes of the device the bookmark employs a base portion 12 adapted for engagement to a book 16. As shown in the mode of FIG. 1, extending from an engagement end to the edge or other position on the base 12, a tail portion 18 extends to its distal end from a connection to the base 12. As noted, to prevent damage to the book 16, the tail portion 18 is planar or very thin and of sufficient elongation such that when engaged between book pages 20 for prolonged periods, the tail portion 18 will not cause damage to the book 16. Especially preferred materials for the tail portion 18 come from a group include thread, planar strips of paper, plastic or foil, or other very thin yet tear-resistant materials.

The base portion 12 is engageable to the book 16 using means of engagement which will not harm the book 16, which as noted is especially important since some books can become very valuable. Removably engageable adhesive 22, such as that used for conventional post-notes, which is adapted to hold the base portion 12 upon the book spine 13 or book covers 17 or possibly the book pages 20, allows for subsequent removal and replacement of the bookmark without damage to the mounting surface should be employed. The adhesive 22 would be best adapted to allow for a sequential engagement of the base portion 12 to a plurality of books when the device 10 is employed to show achievement by the user so it may be placed on each new book.

Placing the base portion 12 on the spine 13 or cover 17 is especially preferred if sponsor or commercial advertising is a consideration. Indicia 27 regarding the advertiser would thereby be easily readable by third parties as the book 16 is carried about. If the base portion 12 is a bright or highly recognizable color, the indicia 27 will be much easier to read from a distance. Of course when distributed by advertisers or with advertising for goods which generates revenue for the distributor, the bookmark devices 10 would be significantly reduced in cost to the user, if not free, which would encourage use.

As noted, at a first end the tail portion 18 is engaged to the base portion 12 and the tail portion extends to its distal end. For use as intended in one mode of employment, the tail portion 18 should be either a planar tail portion 18 and very thin, or threadlike as thread tail portion 19 and also very thin, so as not to harm the book 16 or the pages 20 when compressed therebetween. Currently preferred materials for the tail portion 18 include threads, ribbons, plastic or foil strips, and paper, and all work particularly well for this purpose. Depending on the use of the device 10 for a particular method or system, some types of materials will be more well adapted to carry indicia or be rendered frangible or peelable in layers.

The device 10 by itself, is a particularly useful and novel improvement in bookmarks since it is removably attachable to the book 16, thereby maintaining it in proximity to the book being read and preventing loss which occurs with conventional bookmarks which fall out of the pages, or may be removed from the pages and left behind or lost accidentally. The mode using removable adhesive 22 would work best for this purpose since the bookmark could be engaged to the cover or spine and left in place during reading sessions. In combination with the various methods of reward and encouragement the modes herein provide, the device 10 becomes particularly useful.

The device 10 works particularly well used in a method of inducement to increase reading by young readers. Children and adolescents are motivated by a number of things. Some children are encouraged by the receipt of plaques and awards, some by receipt of tangible rewards, and some by a combination of both.

Employed for a method of inducement to read, in a particularly preferred mode, the device 10 configured as in FIG. 9, would carry sequential indicia 30 that would be revealed by peeling away different layers forming separable portions in sections 33 which are engaged upon each other with removable adhesive to the base portion 12. The indicia 30 would display numbers or symbols which will connote increasing achievement by the holder of the device 10 to third parties. Or, the entire top layer could peel off in layers, revealing underlying sequential indicia 30 showing ever increasing numbers representing more books read by the proud reader.

The sections 33 might also be layered to the tail portion 18 and sequentially removed; however, the base portion 12 would be more preferred unless the sections 33 on the tail portion 18 are made thin enough not to cause damage to the book when the tail portion 18 is employed as a bookmark.

Additionally, the use of sections 33 might also be combined with the removable sectional portions 38 of FIG. 7 to allow for incremental encouragement by indicia on the layered sections 33 and inducement with products or discounts or coupons from the sections 38 on FIG. 7. This would not only provide inducement to people who appreciate certificate or award of the indicia of the layered sections 33, it would give them positive reinforcement with actual physical rewards claimed by turning in the coupons or award certificates on the sections 38 which would be removed sequentially along with the layered sections 33.

In this fashion, upon reading one book the reader would be rewarded with the privilege of a device 10 carrying the numeral “1” after reading the first book. With each additional book read by the reader, a layer would be allowed to be peeled away and a higher number would be displayed showing the accomplishment. The device 10 can be easily moved from book to book using the adhesive 22 or other removable means for engagement.

Once a certain reading threshold is reached by the reader, a symbol 31 such as a gold star, which is highly visible to others, would be displayed by peeling away the last of the sequential sections 33 or entire layers on the device 10, to thereby reveal the gold star or symbol 31 of choice. Students responding to plaque and award type inducement would increase their reading to reach the ever higher award indicia symbols 31.

Since the device 10 on its bottom surface is adapted for removable engagement to a plurality of different books, the student would simply peel the device 10 from the previous read book, peel off a layer to reveal the higher sequential number, and place it on the current book being read. The gold star or other symbol of achievement 31 would be displayed once the last layer is peeled away. Or, the final underlying indicia on the bottommost layer may be an award which would have enlarged indicia and gold star or symbol 31 and could be framed or otherwise kept by the student. In this case, a new device 10 would be used for subsequent books and so on.

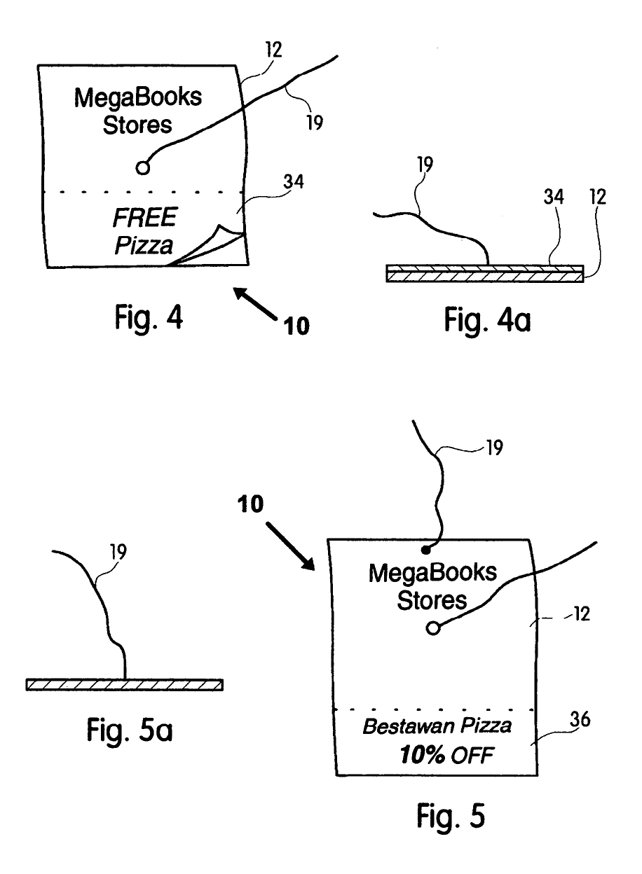

The bookmark devices 10 for these awards in this inducement method may be distributed by book vendors or schools in the classrooms as badges of accomplishment. For additional inducement to read, a detachable portion would be attached to the base portion or the tail portion. As shown in FIGS. 4-5, a coupon 36 in FIG. 5, may be placed on a detachable portion in the form of a peel away separable portion 34, or a tear-off separable portion forming the coupon 36 as in FIG. 5. Or the tail portion 18 might have one or a plurality of detachable portions 38 forming it as in FIG. 7. The tail portion 18 used to provide coupons in such removable sectional portions 38, would be made extra long to allow it to still function as a book mark. Such removable sectional portions 38 may also be sequentially employed with each subsequent removable sectional portion 38 yielding an increasing award in the form of a coupon or prize which can be claimed with the removed sectional portion 38.

Readers finishing a book or increasing amounts of books would be allowed to tender the coupon portions separated from the base portion 12 or tail portion 18 for prizes, products, or discounts. This material inducement can be employed separately or in combination with the aforementioned award inducement, to thereby encourage the increased reading by students and readers in general.

When employed in a method to induce reading using rewards, a series of reading milestones would best be designated to the reader. In this method form, for each milestone reached or exceeded, the reader would be able to turn in a coupon for a reward indicated on the indicia 27. When used in combination with the award indicia noted above, both awards and coupons could be given to the reader for reaching the milestones, all of which would be positioned on the device 10 which would be attached to the book being read so neither the coupons nor awards are lost and serve as a constant reminder to the reader during reading sessions.

As noted, the device 10 is particularly well employed for a system of advertising. Used to advertise a product, a service or a store, bookmark devices 10 would have indicia 27 identifying the name or logo or other identifier of the advertiser such as in FIGS. 1-5. The bookmarks could be given away for free or at significantly reduced prices because they are attachable to the spine or cover of the book and while so attached the devices 10 provide moving billboards for the advertisers. Particularly preferred would be a book seller advertiser since the book being carried by the reader would be viewed by other readers who would know where the book may be purchased. Further, particularly preferred would be the inclusion of a separable portion 34 in the form of a coupon such as in FIGS. 5 or 7 since the reader would constantly be reminded of the goods or services on the coupon during reading sessions, and other people viewing the coupons would know they may too get discounts at the vendor.

Additionally, used for advertising the device 10 would insure inexpensive distribution since revenue to cover costs and shipment could be developed by payments from the advertisers. This would, as noted, make the device easier to come by for readers. The separable portion 34 carrying the coupon 36 might also be a detachable portion peelable from a multilayer base portion as shown in FIG. 4 which would allow for advertising by one vendor on the base portion 12 and coupons for one or a plurality of different advertisers upon the peelable separable portions 34.

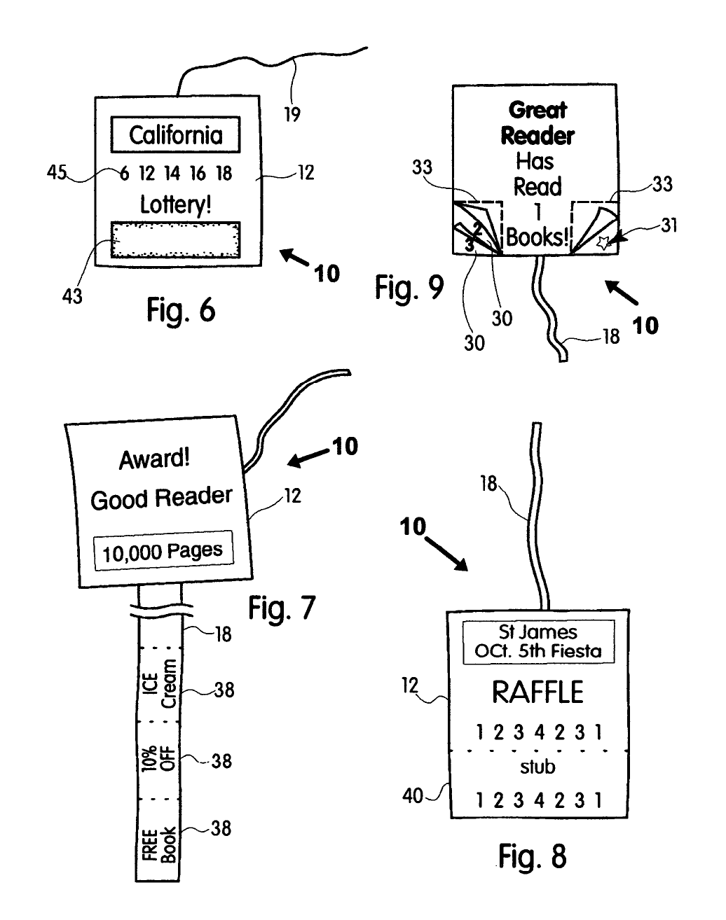

The device 10 is also particularly well suited to be employed as a raffle ticket as in FIG. 8, with a separable portion 34 becoming a raffle stub 40 and the advertising or notice of the date of the event of the raffle being on the base portion 12. Used as a bookmark, the device 10 will be a constant advertisement for the annual or upcoming event. Or the device 10 may be employed as a lottery ticket as in FIG. 6, with the base portion 12 having a scratch off section 43 common to lottery tickets or being imprinted with the chosen numbers 45 chosen by the holder. The device 10 will become a walking billboard for the lottery just as with advertisers when carried around on a book. The lottery or advertisers with such advertising in mind would most probably provide the users with free bookmarks encouraging reading when buying lottery tickets.

Finally, the device 10 and method herein might also be employed for fund raising by Parent Teacher Associations and the like. In this mode, rather than selling candy or magazines, the devices 10 would be sold to parents and town residents as bookmarks with coupons 36 such as in FIG. 5, forming the separable portions. The coupons being discounts for local and national merchants would have a value exceeding the cost for the bookmark, thereby encouraging purchase and fund-raising for the school.

While all of the fundamental characteristics and features of the bookmark based device and method for reading encouragement and fund-raising and advertising have been disclosed and described, with reference to particular embodiments thereof, a latitude of modifications, various changes and substitutions are intended in the foregoing disclosure, and it will be apparent that in some instances, some features of the invention will be employed without a corresponding use of other features without departing from the scope of the invention as set forth. It should also be understood, that elements of different construction and configuration and different steps and process procedures and other arrangements thereof, other than those illustrated and described, may be employed for providing the apparatus and any method herein within the spirit of this invention.

As such, while the present invention has been described herein with reference to particular embodiments thereof, a latitude of modifications, various changes and substitutions are intended in the foregoing disclosure, without departing from the scope of the invention as set forth in the following claims. All such changes, alternations and modifications as would occur to those skilled in the art, are considered to be within the scope of this invention as broadly defined in the appended claims.

What is claimed is:

1. A bookmark for engagement to the spine, covers, or pages of a book, comprising:
a substantially planar base portion;
an elongated tail portion, said tail portion engaged to said base portion at a first end and extending to a distal end;
means for removable engagement of said base portion to said book;
indicia positioned on said bookmark;
said indicia providing one or a combination of, a coupon, an indicator of increasing reading achievement, or advertising; and
whereby a user of said bookmark is encouraged to read said book by one or a combination of a reward claimed with said coupon, or a display of said indicator of increasing reading achievement for viewing by third parties.

2. The bookmark of claim 1 additionally comprising:
separable portions engaged to said bookmark;
said separable portions being one or a plurality of overlying said separable portions overlain upon underlying said separable portions;
said indicia located on said overlying separable portions and said underlying separable portions;
said indicia located on said underlying separable portions indicating increasing achievement from said indicia on each respective said overlying separable portion; and
removal of said overlying separable portions revealing said indicia on said respective underlying separable portions, thereby providing said indicator of increasing reading achievement whereby a bearer of said bookmark may be encouraged to ready.

3. The bookmark of claim 2 additionally comprising:
said separable portions engaged upon said tail portion.

4. The bookmark of claim 2 additionally comprising:
said separable portions engaged upon said base portion.

5. The bookmark of claim 1 additionally comprising:
one or a plurality of secondary separable portions engaged to said tail portion;
said indicia located on said secondary separable portions; and
said secondary separable portions being a said coupon removable to claim an award or prize, whereby means to encourage a reader to read more is provided by said secondary separable portions and the reward or prize they may be tendered for once removed from said tail portion.

6. The bookmark of claim 2 additionally comprising:
one or a plurality of secondary separable portions engaged to said tail portion;
said indicia located on said secondary separable portions; and
said secondary separable portions being a said coupon removable to claim an award or prize, whereby means to encourage a reader to read more is provided by said secondary separable portions and the reward or prize they may be tendered for once removed from said tail portion.

7. A bookmark for engagement to the spine, covers, or pages of a book, comprising:
a substantially planar base portion;
an elongated tail portion, said tail portion engaged to said base portion at a first end and extending to a distal end;
means for removable engagement of said base portion to said book;
at least one separable portion engaged to said bookmark;
indicia positioned on said separable portion;
said indicia being one of a group including a raffle ticket receipt, a lottery ticket receipt, or a coupon; and
said separable portion thereby providing means to encourage reading by a user of said bookmark removing said separable portion for a reward for reading.

8. The bookmark of claim 5 wherein said means for removable engagement of said base portion to said book comprises:
adhesive, said adhesive adapted to engage said base portion to a plurality of books whereby said bookmark may be sequentially engaged to a series of said books being read by a reader.

9. The bookmark of claim 6 wherein said means for removable engagement of said base portion to said book comprises:
adhesive, said adhesive adapted to engage said base portion to a plurality of books whereby said bookmark may be sequentially engaged to a series of said books being read by a reader.

10. A method for encouraging reading of books by readers who achieve a predefined reading goal using bookmarks having indicia thereon to indicate increasing achievement by the user, or having indicia thereon on removable portions as coupons for inducement to increase reading, comprising the steps of:
tendering a said bookmark to a reader for engagement of said bookmark to a book;
allowing said reader to sequentially remove portions of said bookmark upon an achievement of a said predefined reading goal;
allowing said reader to display said indicia on said bookmark which indicates their achievement of the said predefined goal if said indicia is provided to indicate said predefined goal; and
allowing said reader to remove said removable portion upon a reaching of said predefined reading goal and to tender said coupon in trade for a reward should said indicia be provided a said coupon.

11. The method for encouraging reading of claim 10 comprising the additional steps of:
providing said bookmarks with both indicia thereon to indicate an achievement of said predefined goal and indicia upon removable portions as a said coupon;
allowing said reader to display said indicia on said bookmark which indicates their achievement of the predefined reading goal upon reaching said predefined reading goal; and
allowing said reader to remove a said coupon from said bookmark for a trade-in for a reward upon a reaching of said predefined reading goal.

12. The method for encouraging reading of claim 10 comprising the additional steps of:
allowing said reader to remove said bookmark from a first said book and engage it to a second said book.

13. The method for encouraging reading of claim 11 comprising the additional steps of:
allowing said reader to remove said bookmark from a first said book and engage it to a second said book with and to display said indicia on said bookmark which indicates their achievement of said predefined reading goal, while engaged on said second book.
